(19) United States
(12) Patent Application Publication
(10) Pub. No.: US 2018/0074327 A1
(43) Pub. Date: Mar. 15, 2018

(54) NON-TRANSITORY COMPUTER-READABLE STORAGE MEDIUM, INFORMATION PROCESSING TERMINAL, AND INFORMATION PROCESSING METHOD

(71) Applicant: FUJITSU LIMITED, Kawasaki-shi (JP)

(72) Inventors: Yoshihide Fujita, Kawasaki (JP); Akinori Taguchi, Kawasaki (JP); Motonobu Mihara, Kawasaki (JP)

(73) Assignee: FUJITSU LIMITED, Kawasaki-shi (JP)

(21) Appl. No.: 15/689,423

(22) Filed: Aug. 29, 2017

(30) Foreign Application Priority Data
Sep. 13, 2016 (JP) 2016-178622

(51) Int. Cl. G02B 27/01; G06F 3/0481

(52) U.S. Cl. CPC G02B 27/0172; G06F 3/04815; G02B 2027/0141; G02B 2027/014; G02B 2027/0138

(57) ABSTRACT

A non-transitory computer-readable storage medium storing an information processing program that causes a computer to execute a process, the process including capturing an image by using a first camera included in an information processing terminal, detecting a gaze direction of a user included in the image when presented information is displayed on a screen of the information processing terminal, capturing an image by using a second camera included in the information processing terminal when the presented information is displayed on the screen, and performing an output control of warning corresponding to the presented information based on the detected gaze direction and the image captured by using the second camera.

### CROSS-REFERENCE TO RELATED APPLICATION

This application is based upon and claims the benefit of priority of the prior Japanese Patent Application No. 2016-178622, filed on Sep. 13, 2016, the entire contents of which are incorporated herein by reference.

### FIELD

The embodiments discussed herein are related to a non-transitory computer-readable storage medium, an information processing terminal, and an information processing method.

### BACKGROUND

In a daily checking work, a technique that uses a mounting type information processing terminal such as a head-mounted display (hereinafter, referred to as HMD) has been developed. For example, when performing a checking work for a facility, equipment, or the like, a worker reads an instruction or confirms an item to be checked that is displayed on a screen of the HMD, and then performs the checking work. In this manner, the worker may reduce errors in work.

An information input-output device that urges a user to check information displayed on a screen by emitting a sound when the user is not able to watch the screen has been known (for example, refer to Japanese Laid-open Patent Publication No. 2014-145734).

### SUMMARY

According to an aspect of the invention, a non-transitory computer-readable storage medium storing an information processing program that causes a computer to execute a process, the process including capturing an image by using a first camera included in an information processing terminal, detecting a gaze direction of a user included in the image when presented information is displayed on a screen of the information processing terminal, capturing an image by using a second camera included in the information processing terminal when the presented information is displayed on the screen, and performing an output control of warning corresponding to the presented information based on the detected gaze direction and the image captured by using the second camera.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of an information processing terminal according to an embodiment;

FIG. 2 is a diagram illustrating an example of a position of a display device when the information processing terminal is mounted;

FIG. 3 is a block diagram illustrating an example of processing executed by the information processing terminal according to the embodiment;

FIG. 4 is a diagram illustrating an example of a hardware configuration of the information processing terminal according to the embodiment;

FIG. 5 is a flowchart illustrating an example of processing related to warning necessity determining processing of the information processing terminal;

FIG. 6 is a flowchart illustrating an example of processing of a state detecting unit;

FIG. 7 is a flowchart illustrating an example of processing related to viewing determination processing;

FIG. 8 is a flowchart illustrating an example of processing related to movement determination processing of the display device;

FIG. 9 is a block diagram illustrating an example of processing which is executed by an information processing terminal according to another embodiment;

FIG. 10 is a flowchart illustrating an example of processing related to viewing determination processing according to still another embodiment; and

FIG. 11 is a flowchart illustrating an example of processing related to movement determination processing of a display device according to still another embodiment.

### DESCRIPTION OF EMBODIMENTS

When a user performs a checking work while wearing the HMD, view of the user is obstructed by a display screen. Therefore, a user often works after putting the display screen aside from the field of view. However, when a user works in a state where the user does not view the display screen, warning may be output in some cases to the user to view the display screen even after the user has viewed the display screen once.

According to an aspect, an object thereof is to accurately determine that a user checked display contents.

The disclosure according to the embodiment pays attention to a change in image photographed by a first camera and a second camera, when a user moves a display screen to the head from a state where the user can view the display screen.

When a user moves a display screen to the head from a state where the user can view the display screen, an image of the outside world (image in front of user) which is photographed by the second camera moves downward. Therefore, the HMD in the embodiment determines that a display screen is moved by the user, when the image of the outside world moves downward by a predetermined amount or more.

When presented information is displayed on the display screen, the first camera photographs eyes of a user facing the display screen. The HMD determines whether or not the user viewed (checked) the display screen for a predetermined time or more using a photographed image of eyes of the user. When the user views the display screen for a predetermined time or more, the HMD does not output warning to the user. On the other hand, when the user does not view the display screen for a predetermined time or more, the HMD outputs warning to the user.

For this reason, the HMD according to the embodiment determines whether or not the display screen is intendedly moved after the user viewed the display screen, and does not output unnecessary warning to the user.

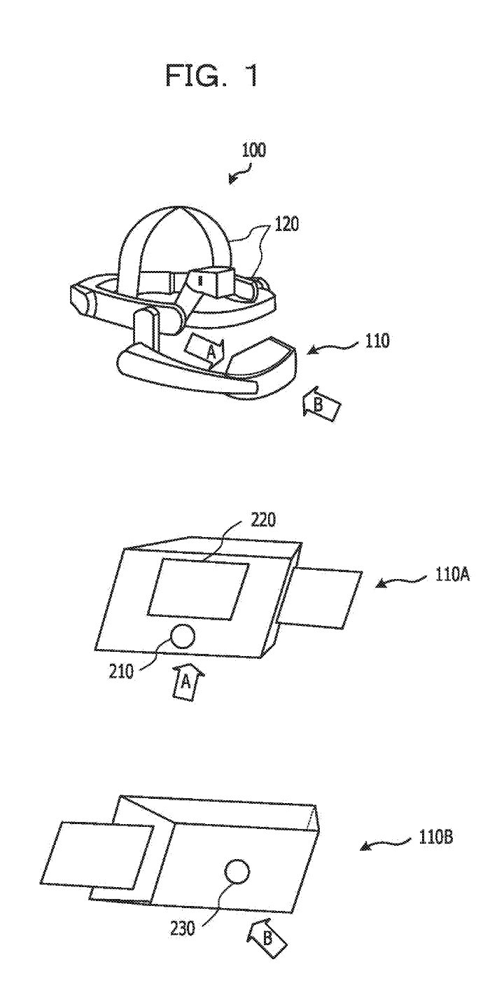

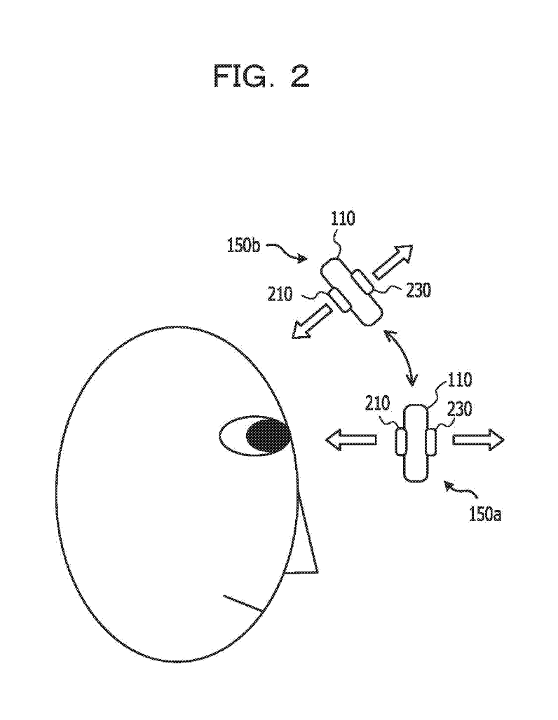

FIG. 1 is a diagram which describes a configuration example of an information processing terminal according to the embodiment. FIG. 2 is a diagram which describes an example of a position of the display device when mounting the information processing terminal. An information processing terminal 100 in FIG. 1 is a head mounted display of a monocular system which is provided with a display device 110, and a head band 120 which supports the display device 110 mounted on the head of a user. The information processing terminal 100 is mounted on the head of a user, and is used as auxiliary equipment when the user performs a checking work. The display device 110 may be used in any one of a right eye and a left eye of a user.

A display device 110a is an example of the display device 110 when viewed from an arrow A direction. The display device 110a is provided with a display 220 which displays presented information in front of an eye of a user, and a first camera 210 which photographs an eye of the user which faces the display 220. A display device 110b is an example of the display device 110 when viewed from an arrow B direction. The display device 110b is provided with a second camera 230 which photographs the front side of the user.

The display device 110 can be moved to a position in front of an eye, and onto the head of a user, as illustrated in FIG. 2. When the display device 110 is in a state 150a where the display device is in front of the eye of the user, the first camera 210 can photograph the eye of the user. Furthermore, when the display device 110 is in the state 150a where the display device is in front of the eye of the user, the second camera 230 can photograph the front direction of the user. Hereinafter, a direction photographed by the second camera 230 is referred to as the outside or the outside world.

In a state 150b where the display device 110 is on the head, the first camera 210 may not photograph the eye of the user, though the camera photographs a direction of the user. Furthermore, in the state 150b where the display device 110 is on the head, the second camera 230 photographs the front-upper side of the user.

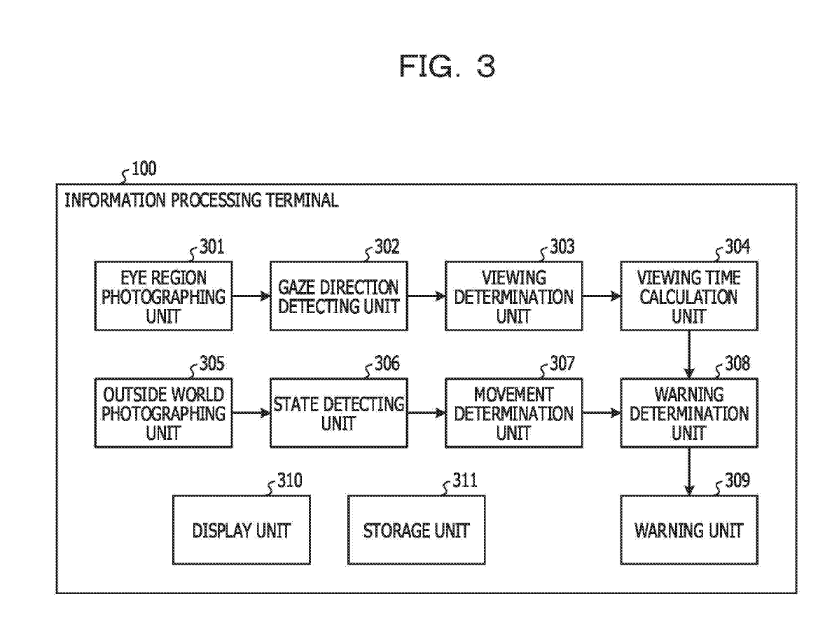

FIG. 3 is a block diagram which describes an example of processing executed by the information processing terminal according to the embodiment. The information processing terminal 100 is provided with an eye region photographing unit 301, a gaze direction detecting unit 302, a viewing determination unit 303, a viewing time calculation unit 304, an outside world photographing unit 305, a state detecting unit 306, a movement determination unit 307, a warning determination unit 308, a warning unit 309, a display unit 310, and a storage unit 311. The storage unit 311 is a memory which can store an image photographed by the eye region photographing unit 301 or the outside world photographing unit 305.

The display unit 310 displays presented information such as information denoting information related to progressing of a work, or work contents in a checking work. The eye region photographing unit 301 is the first camera 210. The eye region photographing unit 301 photographs a direction of a user with a predetermined time interval when presented information is displayed on the display unit 310. The eye region photographing unit 301 can photograph an eye of a user in a state 150a where the display device 110 is in front of the eye of the user. The eye region photographing unit 301 may not photograph the eye of the user in the state 150b where the display device 110 is on the head.

The gaze direction detecting unit 302 detects a gaze direction based on an eye image of a user which is photographed by the eye region photographing unit 301. When the eye region photographing unit 301 photographs an image in a state 150b where the display device 110 is on the head, the gaze direction detecting unit 302 may not detect the gaze direction.

The viewing determination unit 303 determines whether or not the gaze direction detected in the gaze direction detecting unit 302 goes toward the display unit 310. The viewing time calculation unit 304 adds (integrates) a time which is determined to be a time in which a gaze direction of a user goes toward the display unit 310 in a predetermined time, in the viewing determination unit 303.

The outside world photographing unit 305 is the second camera 230. When presented information is displayed on the display unit 310, the outside world photographing unit 305 photographs the outside world with a predetermined time interval. The outside world photographing unit 305 can photograph the front direction of a user in the state 150a where the display device 110 is in front of an eye of a user. The outside world photographing unit 305 photographs the front upper side of a user in the state 150b where the display device 110 is on the head.

The state detecting unit 306 determines whether or not a user is at work based on information with which it is possible to determine whether or not tools or hands are photographed in an image photographed by the outside world photographing unit 305, for example. Furthermore, the state detecting unit 306 determines whether or not a user is walking depending on whether an image in the outside world moves or not.

The movement determination unit 307 determines whether or not the display device 110 moved from the state 150a where the display device 110 is in front of an eye of a user to the state 150b where the display device 110 is on the head. Specifically, the movement determination unit 307 extracts feature points from an image in the outside world with the predetermined number of frames in the past. The number of frames of an image in the outside world as a target of extracting feature points can be appropriately changed. Thereafter, the movement determination unit 307 calculates a movement amount of the display device 110 with the predetermined number of frames in the past using a vector value, from the extracted feature points. The movement determination unit 307 determines that the display device 110 moved from the state 150a where the display device 110 is in front of an eye of a user to the state 150b where the display device 110 is on the head, when a vector value of the movement amount is a predetermined value or more. On the other hand, when the vector value of the movement amount does not reach the predetermined value, the movement determination unit 307 determines that the display device 110 does not move from the state 150a where the display device 110 is in front of the eye of the user.

The warning determination unit 308 determines so as not to output warning, when it is determined in the movement determination unit 307 that the display device 110 does not move from the state 150a where the display device 110 is in front of an eye of a user. The warning determination unit 308 determines so as not to output warning in a case where it is determined that the display device 110 moved from the state 150a where the display device 110 is in front of an eye of a user in the movement determination unit 307, and a case where a viewing time calculated in the viewing time calculation unit 304 is a predetermined time or more. In other words, the warning determination unit 308 determines that a user already checked presented information on the display device 110, when the viewing time calculated in the viewing time calculation unit 304 is the predetermined time or more. The warning determination unit 308 determines so as to output warning in a case where it is determined that the display device 110 moved to the state 150a where the display device 110 is in front of an eye of a user in the movement determination unit 307, and a case where the viewing time calculated in the viewing time calculation unit 304 is shorter than the predetermined time. In other words, the warning determination unit 308 determines that a user dose not check the presented information on the display device 110 when the viewing time calculated in the viewing time calculation unit 304 is shorter than the predetermined time. The warning unit 309 outputs warning when the warning determination unit 308 determines so as to output warning.

In this manner, in the information processing terminal 100 according to the embodiment, the outside world photographing unit 305 photographs an image in front of a user when presented information is displayed on the display unit 310. The movement determination unit 307 determines that the display device 110 is in the state 150a where the display device 110 is in front of an eye of a user, based on an image photographed by the outside world photographing unit 305. In addition, the eye region photographing unit 301 photographs the eye of the user when presented information is displayed on the display unit 310. When the display device 110 is in the state 150a where the display device is in front of the eye of the user, the warning determination unit 308 determines whether or not the user viewed the display unit 310 for a predetermined time or more, and determines whether or not to output warning.

For this reason, the information processing terminal 100 according to the embodiment determines whether or not the display device 110 is intendedly moved after a user viewed the display unit 310, and does not output unnecessary warning to a user.

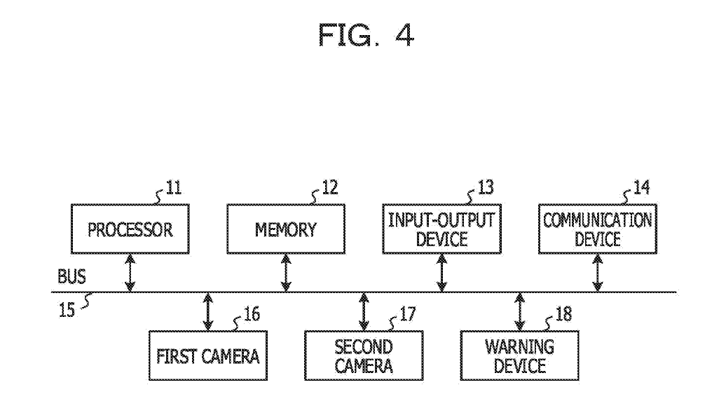

FIG. 4 is a diagram which describes an example of a hardware configuration of the information processing terminal according to the embodiment. The information processing terminal 100 is provided with a processor 11, a memory 12, an input-output device 13, a communication device 14, a bus 15, a first camera 16, a second camera 17, and a warning device 18.

The processor 11 is an arbitrary processing circuit such as a central processing unit (CPU). The processor 11 may be a plurality of CPUs. The processor 11 works as the gaze direction detecting unit 302, the viewing determination unit 303, the viewing time calculation unit 304, the state detecting unit 306, the movement determination unit 307, and the warning determination unit 308 in the information processing terminal 100. In addition, the processor 11 can execute a program stored in the memory 12. The memory 12 works as the storage unit 311. The memory 12 appropriately stores data obtained by the work of the processor 11, or data used in processing of the processor 11, as well. The communication device 14 is used in a communication with other devices.

The input-output device 13 is executed as an input device such as a button, a keyboard, and a mouse, for example, and is executed as an output device such as a display. The output device of the input-output device 13 works as the display unit 310. The warning device 18 outputs warning using sound, vibration, or the like, and works as the warning unit 309. The first camera 16 is a camera which photographs a user direction, and works as the first camera 210, and the eye region photographing unit 301. The second camera 17 photographs the front side of a user in the state 150a where the display device 110 is in front of an eye of the user. The second camera 17 photographs information on the front side of a user in the state 150b where the display device 110 is on the head of a user. The second camera 17 works as the second camera 230 and the outside world photographing unit 305. The bus 15 connects the processor 11, the memory 12, the input-output device 13, the communication device 14, the first camera 16, the second camera 17, and the warning device 18 to each other so that delivery of data can be performed.

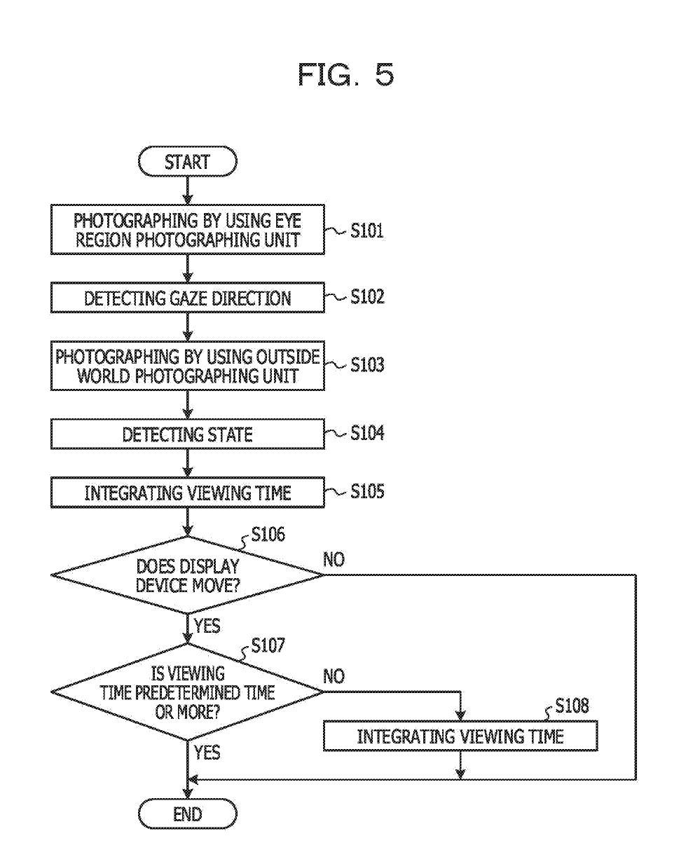

FIG. 5 is a flowchart which describes an example of processing related to warning necessity determining processing of the information processing terminal. The eye region photographing unit 301 photographs an eye image of a user (step S101). The gaze direction detecting unit 302 detects a gaze direction based on the eye image of the user photographed by the eye region photographing unit 301 (step S102). The outside world photographing unit 305 photographs an image of the outside world (front side of user, or front upper side of user) (step S103). The state detecting unit 306 determines whether or not a user is at work (step S104).

The viewing time calculation unit 304 adds a time in which it is determined that a gaze direction of a user goes toward the display unit 310 in the viewing determination unit 303 (step S105). The movement determination unit 307 determines whether or not the display device 110 moved from the front of an eye (state 150a in FIG. 2) (step S106).

When the display device 110 moved from the state 150a where the display device is in front of the eye (Yes in step S106), the warning determination unit 308 determines whether or not a viewing time is a predetermined time or more (step S107). When the viewing time is shorter than the predetermined time (No in step S107), the warning unit 309 outputs warning (step S108). When the process in step S108 ends, or when the time is the predetermined time or more (Yes in step S107), and when the display device 110 does not move from the state 150a where the display device is in front of an eye (No in step S106), processing related to the warning necessity determining processing of the information processing terminal 100 ends.

In addition, the warning necessity determining processing in FIG. 5 according to the embodiment is set to be performed at a predetermined interval while display contents are displayed on the display unit 310.

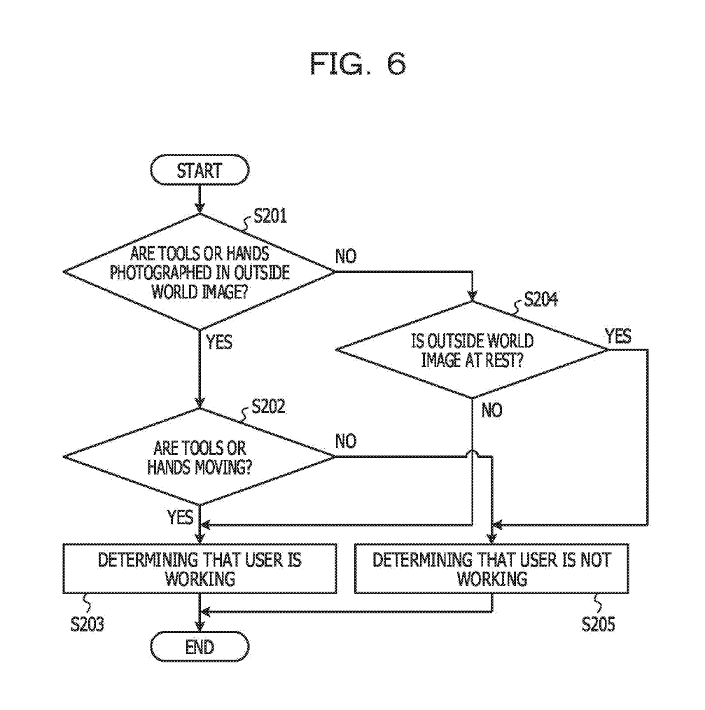

FIG. 6 is a flowchart which describes an example of processing of the state detecting unit. In the processing in the flowchart in FIG. 6, processing in step S104 in FIG. 5 is described in detail. The state detecting unit 306 determines whether or not tools or hands are photographed in the image photographed by the outside world photographing unit 305 (step S201). When tools or hands are photographed in the image photographed by the outside world photographing unit 305 (Yes in step S201), the state detecting unit 306 determines whether or not the tools or hands are moving from the image photographed by the outside world photographing unit 305 (step S202). Here, the state detecting unit 306 determines whether or not the tools or hands are moving, using an image with the predetermined number of frames in the past which is photographed by the outside world photographing unit 305. When the tools or hands are moving (Yes in step S202), the state detecting unit 306 determines that the user is working (step S203).

When the tools or hands are not photographed in the image photographed by the outside world photographing unit 305 (No in step S201), the state detecting unit 306 determines whether or not the outside world photographing unit 305 is at rest, based on the images taken for the predetermined number of frames which are photographed before by the outside world photographing unit 305 (step S204). When the outside world photographing unit 305 is at rest (Yes in step S204), the state detecting unit 306 determines that the user is not working (step S205). Similarly, when the tools or hands are not moving (No in step S202), the state detecting unit 306 determines that the user is not working (step S205). When the outside world photographing unit 305 is not at rest for the predetermined number of frames which are photographed before by the outside world photographing unit 305 (No in step S204), the state detecting unit 306 determines that the user is working (step S203).

When a state of a user, for example, a user is working (step S203), a user is not working (step S204), or the like, is determined, processing in the state detecting unit 306 (step S104 in FIG. 5) ends.

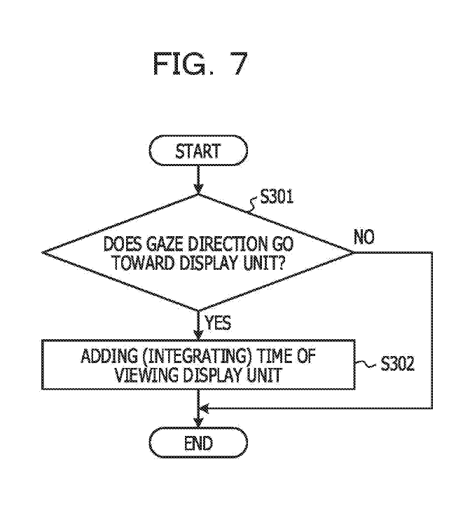

FIG. 7 is a flowchart which describes an example of processing related to the viewing determining processing. In the processing in the flowchart in FIG. 7, processing in step S105 in FIG. 5 is described in detail.

The viewing determination unit 303 determines whether or not a gaze direction goes toward the display unit 310 (step S301). When the gaze direction goes toward the display unit 310 (Yes in step S301), the viewing time calculation unit 304 integrates viewing times (step S302). When the gaze direction does not go toward the display unit 310 (No in step S301), or step S302 ends, the viewing determination processing related to FIG. 7 ends.

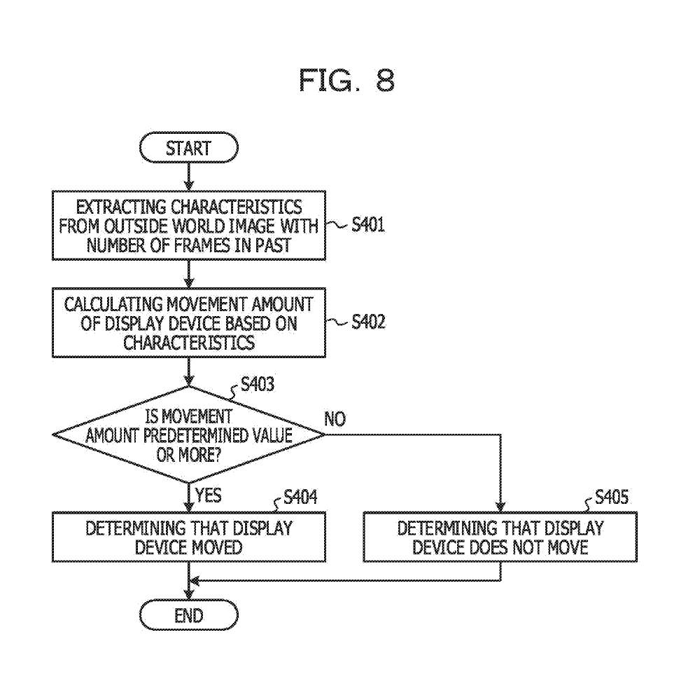

FIG. 8 is a flowchart which describes an example of processing related to movement determination processing of the display device. In the processing in FIG. 8, the processing in step S106 in FIG. 5 is described in detail. The movement determination unit 307 extracts feature points from an image of the outside world with the predetermined number of frames in the past (step S401). The movement determination unit 307 calculates a vector value of a movement amount of the display device 110 in the predetermined number of frames in the past from the extracted feature points (step S402). The movement determination unit 307 determines whether or not the vector value of the movement amount is a predetermined value or more (step S403).

When the vector value of the movement amount is the predetermined value or more (Yes in step S403), the movement determination unit 307 determines that the display device 110 moved from the state 150a (in front of eye) (step S404). When the vector value of the movement amount is smaller than the predetermined value (No in step S403), the movement determination unit 307 determines that the display device 110 does not move from the state 150a (step S405). When processing in step S404 or S405 ends, the movement determination unit 307 ends the movement determination processing of the display device 110.

In this manner, in the information processing terminal 100 according to the embodiment, the outside world photographing unit 305 photographs an image in front of a user when presented information is displayed on the display unit 310. The movement determination unit 307 determines that the display device 110 is in the state 150a where the display device is in front of an eye of a user, based on the image photographed by the outside world photographing unit 305. In addition, when presented information is displayed on the display unit 310, the eye region photographing unit 301 photographs the eye of the user. When the display device 110 is in the state 150a where the display device is in front of the eye of the user, the warning determination unit 308 determines whether or not the user viewed the display unit 310 for a predetermined time or more, and determines whether or not to output warning.

For this reason, the information processing terminal 100 according to the embodiment determines whether or not the display device 110 is intendedly moved after a user viewed the display unit 310, and does not output unnecessary warning to the user.

### Other Embodiments

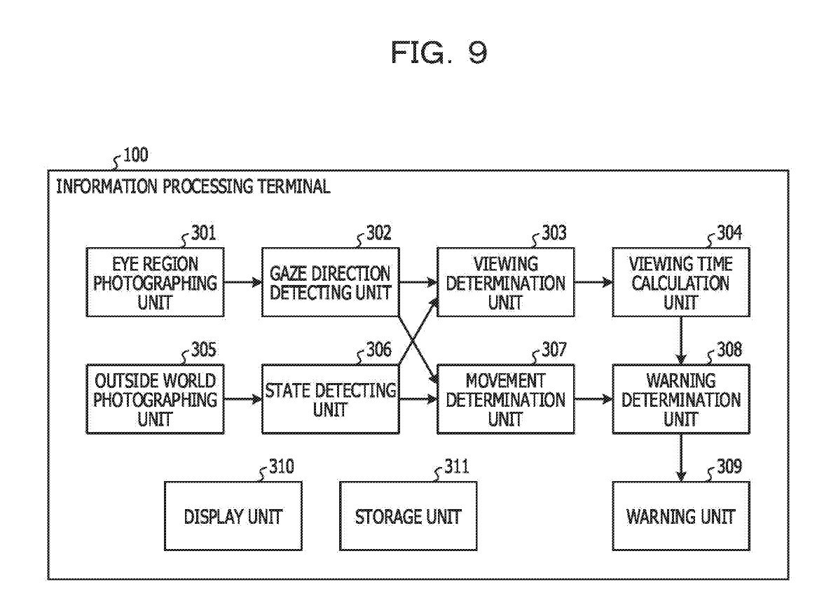

FIG. 9 is a block diagram which describes an example of processing executed by an information processing terminal according to another embodiment. In FIG. 9, the same numbers are attached to the same elements in FIG. 3. FIG. 9 is a diagram in which an arrow from a state detecting unit 306 to a viewing determination unit 303, and an arrow from a gaze direction detecting unit 302 to a movement determination unit 307 are further added, from the block diagram in FIG. 3.

The viewing determination unit 303 according to another embodiment obtains state information on whether or not a user is working from the state detecting unit 306, based on an image of the outside world. A viewing time calculation unit 304 does not integrate viewing times when the state detecting unit 306 determines that the user is not working, even when a gaze direction of the user goes toward the display unit 310. In this manner, it is possible to exclude a time in which a user is simply gazing at the display unit 310 at a time of not working from the viewing time, and accurately determine that the user checked display contents.

The movement determination unit 307 in another embodiment determines whether or not the display device 110 moved from the state 150a where the display device is in front of an eye of a user, by further using an image photographed by the eye region photographing unit 301, from the movement determination of the display device 110 using the image in the outside world. The movement determination unit 307 determines whether or not an eye is photographed in the image photographed by the eye region photographing unit 301. When the eye is photographed in the image, the movement determination unit 307 determines that the display device 110 does not move from the state 150a where the display device is in front of an eye. Meanwhile, when the eye is not photographed in the image, the movement determination unit 307 determines that the display device 110 moved from the state 150a where the display device is in front of an eye. In this manner, it is possible to further accurately perform a position determination whether the display device 110 is in front of an eye or on the head.

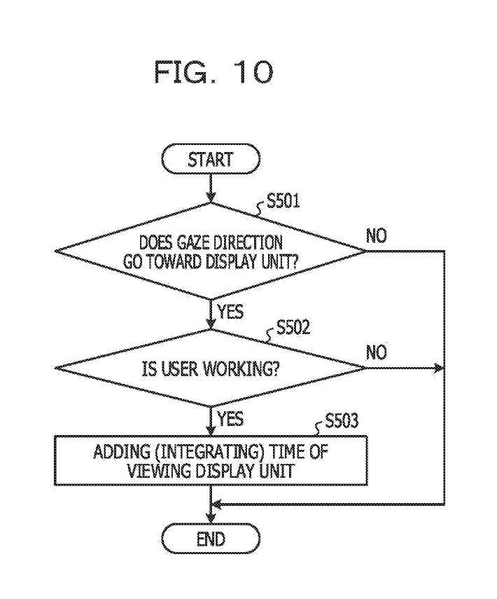

FIG. 10 is a flowchart which describes an example of processing related to viewing determination processing according to another embodiment. An information processing terminal 100 according to another embodiment executes processing related to the flowchart in FIG. 10 using the processing in step S105 in FIG. 5.

The viewing determination unit 303 determines whether or not a gaze direction goes toward the display unit 310 (step S501). When the gaze direction goes toward the display unit 310 (Yes in step S501), the viewing determination unit 303 determines information denoting whether or not a user is working, which is obtained from the state detecting unit 306, is information denoting that the user is working (step S502). When obtaining the information denoting that the user is working from the state detecting unit 306 (Yes in step S502), the viewing time calculation unit 304 integrates the viewing time (step S503).

When the gaze direction does not go toward the display unit 310 (No in step S501), and when information denoting that a user is not working is obtained (No in step S502), the viewing time calculation unit 304 ends the processing related to the viewing determination processing.

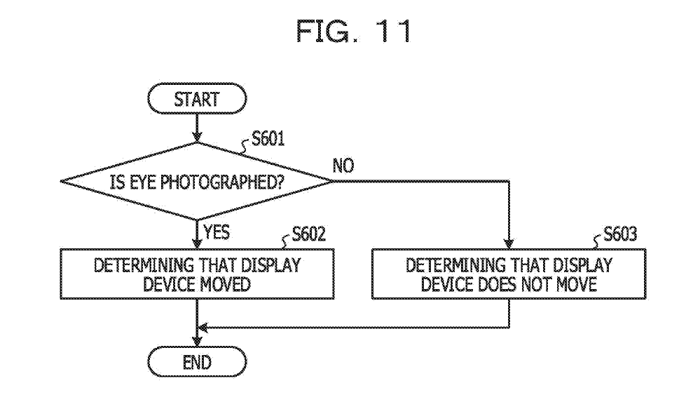

FIG. 11 is a flowchart which describes an example of processing related to movement determination processing of a display device according to another embodiment. An information processing terminal 100 according to another embodiment executes processing related to the flowchart in FIG. 11 using the processing in step S106 in FIG. 5.

The movement determination unit 307 determines whether or not an eye is photographed in the image with the predetermined number of frames in the past which is photographed by the eye region photographing unit 301 (step S601). When the eye is photographed in the image with the predetermined number of frames in the past which is photographed by the eye region photographing unit 301 (Yes in step S601), the movement determination unit 307 determines that the display device 110 does not move from the state 150a where the display device is in front of the eye (step S602). When the eye is not photographed in the image with the predetermined number of frames in the past which is photographed by the eye region photographing unit 301 (No in step S601), the movement determination unit 307 determines that the display device 110 moved from the state 150a where the display device 110 is in front of the eye (step S603).

The movement determination unit 307 may determine whether or not the display device 110 moved from the state 150a where the display device 110 is in front of an eye using any one of the image photographed by the outside world photographing unit 305 and the eye region photographing unit 301. Furthermore, the movement determination unit 307 may use both the image photographed by the outside world photographing unit 305 and the eye region photographing unit 301 when determining whether or not the display device 110 moved from the state 150a where the display device 110 is in front of an eye.

The warning determination unit 308 may determine so as not to output warning when a user has checked the same display contents before, even when determining that the user does not check the display unit 310.

Furthermore, the warning determination unit 308 may determine to output warning when display contents are changed in a state where the display device 110 is on the head, even when determining so as not to output warning.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing an information processing program that causes a computer to execute a process, the process comprising:
capturing an image by using a first camera included in an information processing terminal;
detecting a gaze direction of a user included in the image when presented information is displayed on a screen of the information processing terminal;
capturing an image by using a second camera included in the information processing terminal when the presented information is displayed on the screen; and
performing an output control of warning corresponding to the presented information based on the detected gaze direction and the image captured by using the second camera.

2. The non-transitory computer-readable storage medium according to claim 1, wherein the process comprises:
measuring a view time that is time the detected gaze direction goes toward the screen; and
determining that the user checked the presented information displayed on the screen when the view time is a predetermined time or more.

3. The non-transitory computer-readable storage medium according to claim 1, wherein the process comprises:
extracting a plurality of feature points from the image captured by using the second camera;
calculating a vector value of a movement amount of the display device based on the plurality of feature points; and
determining that the user is working when the vector value is smaller than a predetermined value.

4. The non-transitory computer-readable storage medium according to claim 1, wherein the process comprises:
extracting a plurality of feature points from the image captured by using the second camera;
calculating a vector value of a movement amount of the display device based on the plurality of feature points; and
determining that the screen is not at a position that the user is able to view when the vector value is a predetermined value or more.

5. The non-transitory computer-readable storage medium according to claim 1, wherein the process comprises:
measuring a view time that is time the detected gaze direction goes toward the screen; and
determining that the user did not check the presented information displayed on the screen when the view time is shorter than a predetermined time.

6. The non-transitory computer-readable storage medium according to claim 5, wherein
the output control includes a control so that the warning is not output when it is determined, in the determining, that the user did not check the presented information and when the user has checked display contents which are the same as the display contents before the determining.

7. The non-transitory computer-readable storage medium according to claim 1, wherein
the output control includes outputting the warning when the presented information is changed in a state where the screen is not at a position that the user is able to view.

8. An information processing terminal comprising:
a screen;
a first camera;
a second camera;
a memory; and
a processor coupled to the memory and the processor configured to:
capture an image by using the first camera;
detect a gaze direction of a user included in the image when presented information is displayed on the screen;
capture an image by using the second camera when the presented information is displayed on the screen; and
perform an output control of warning corresponding to the presented information based on the detected gaze direction and the image captured by using the second camera.

9. An information processing method executed by a computer, the information processing method comprising:
capturing an image by using a first camera included in an information processing terminal;
detecting a gaze direction of a user included in the image when presented information is displayed on a screen of the information processing terminal;
capturing an image by using a second camera included in the information processing terminal when the presented information is displayed on the screen; and
performing an output control of warning corresponding to the presented information based on the detected gaze direction and the image captured by using the second camera.
